(19) United States
(12) Patent Application Publication
(10) Pub. No.: US 2025/0211356 A1
(43) Pub. Date: Jun. 26, 2025

(54) OPTICAL TRANSMISSION DEVICE AND OPTICAL TRANSMISSION SYSTEM

(71) Applicant: Fujitsu Limited, Kawasaki-shi (JP)

(72) Inventors: Kentaro KAWANISHI, Kawasaki (JP); Goji NAKAGAWA, Sagamihara (JP); Hiroki OI, Kawasaki (JP); Takafumi TERAHARA, Kawasaki (JP); Makoto HASEGAWA, Sapporo (JP); Teppei OHATA, Fukuoka (JP); Tomohiro YAMAUCHI, Kawasaki (JP)

(73) Assignee: Fujitsu Limited, Kawasaki-shi (JP)

(21) Appl. No.: 18/944,898

(22) Filed: Nov. 12, 2024

(30) Foreign Application Priority Data
Dec. 20, 2023 (JP) 2023-214636

(51) Int. Cl. H04J 14/02

(52) U.S. Cl. CPC H04J 14/0202; H04J 14/0221

(57) ABSTRACT

An optical transmission system transmits an optical signal via a plurality of nodes. A first optical transmission device provided on a first node among the plurality of nodes outputs a wavelength division multiplexed (WDM) signal including a wavelength channel configured to propagate an actual signal and a wavelength channel configured to propagate a pseudo signal. A second optical transmission device provided on a second node among the plurality of nodes includes a wavelength processing circuit configured to terminate the pseudo signal in the WDM signal and to generate a second WDM signal by inserting an add signal and a new pseudo signal into unused wavelength channels of the WDM signal after the pseudo signal is terminated.

### CROSS-REFERENCE TO RELATED APPLICATION

This application is based upon and claims the benefit of priority of the prior Japanese Patent Application No. 2023-214636, filed on Dec. 20, 2023, the entire contents of which are incorporated herein by reference.

### FIELD

The embodiments discussed herein are related to an optical transmission device and an optical transmission system that transmits a wavelength division multiplexed signal.

### BACKGROUND

Wavelength division multiplexing (WDM) has become widespread in order to realize large-capacity communication. The WDM multiplexes and transmits a plurality of optical signals using a plurality of different wavelength channels. In addition, interest in broadband wavelength multiplexing (multi-band WDM) is increasing in order to further expand a transmission capacity. In the multi-band WDM, for example, a C-band and an L-band are used.

In WDM transmission for transmitting a WDM signal, a part of power of an optical signal on a short wavelength side is absorbed by an optical signal on a long wavelength side by stimulated Raman scattering (SRS) generated in an optical fiber transmission line. Therefore, if many wavelength channels in the WDM signal stop for some reason and a small number of wavelength channels remain, the influence of stimulated Raman scattering changes, and the optical power of the remaining wavelength channel temporarily or transiently fluctuates. In the following description, this phenomenon may be referred to as a transient response (or transient).

In a large-scale optical transmission system, the WDM signal is transmitted via a large number of spans. The transient response caused by stimulated Raman scattering occurs in each span. For this reason, when many wavelength channels in the WDM signal stop as described above, transient responses are accumulated, and thus a transmission error may occur. Alternatively, when the optical power of the remaining wavelength channel increases, an optical receiver may be destroyed.

It is noted that a configuration using dummy light to prevent destruction of a receiver has been proposed (for example, Japanese Laid-open Patent Publication No. 2012-100103).

In a WDM transmission system, a technique for stabilizing optical power of each wavelength channel in a feedback system including a variable optical attenuator is known. However, a transient response caused by stimulated Raman scattering is very fast and, as such, it is difficult to sufficiently suppress the transient response in the feedback system.

### SUMMARY

According to an aspect of the embodiments, an optical transmission system transmits an optical signal via a plurality of nodes. A first optical transmission device provided on a first node among the plurality of nodes outputs a wavelength division multiplexed (WDM) signal including a wavelength channel configured to propagate an actual signal and a wavelength channel configured to propagate a pseudo signal. A second optical transmission device provided on a second node among the plurality of nodes includes a wavelength processing circuit configured to terminate the pseudo signal in the WDM signal and to generate a second WDM signal by inserting an add signal and a new pseudo signal into unused wavelength channels of the WDM signal after the pseudo signal is terminated.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIGS. 1A and 1B are diagrams each illustrating a power shift by stimulated Raman scattering;

FIG. 2 illustrates an example of a transient response generated due to input interruption of a WDM signal;

FIG. 3 illustrates an example of an optical transmission system according to an embodiment of the present disclosure;

FIGS. 4A to 4D, 5A to 5C, 6A to 6D, and 7A to 7C illustrate an operation example of the optical transmission system;

FIG. 8 is a diagram illustrating an effect of transmitting a pseudo signal;

FIG. 9 illustrates an example of a ROADM device provided on each WDM node;

FIG. 10 is a flowchart illustrating an example of a process of the ROADM device;

FIGS. 11A and 11B illustrate an operation example of the ROADM device;

FIG. 12 is a flowchart illustrating a variation of a process of the ROADM device; and

FIG. 13 illustrates a variation of the operation of the ROADM device.

### DESCRIPTION OF EMBODIMENTS

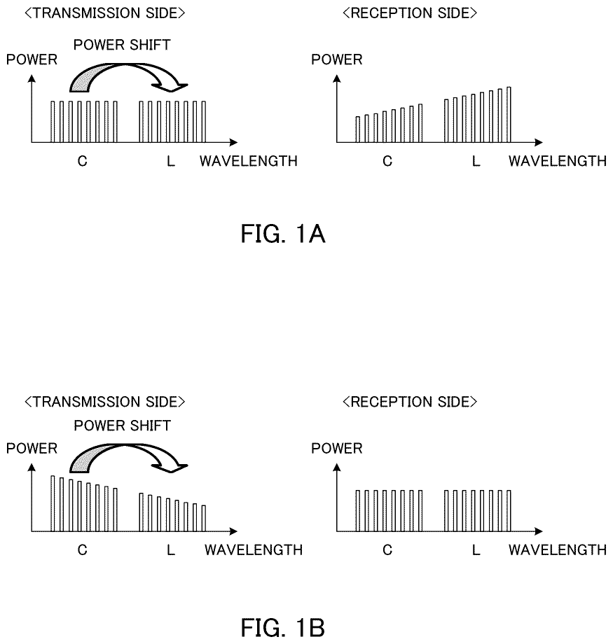

FIGS. 1A and 1B are diagrams illustrating a power shift by stimulated Raman scattering (SRS). When a WDM signal is propagated through an optical fiber, a part of the power of an optical signal in the short wavelength range is absorbed by an optical signal in the long wavelength range by stimulated Raman scattering. That is, a power shift from the short wavelength range to the long wavelength range occurs. For example, as illustrated in FIG. 1A, when the power of each wavelength channel of the WDM signal output from a transmission node is equalized, the WDM signal having the small power in the short wavelength range and the large power in the long wavelength range arrives at a reception node.

In order to suppress a variation in the quality of each wavelength channel, it is preferable that the power of each wavelength channel of the WDM signal arriving at the reception node is equalized. For this reason, for example, as illustrated in FIG. 1B, a WDM signal in which the power in the short wavelength range is large and the power in the long wavelength range is small is generated in the transmission node. Then, since a power shift from the short wavelength range to the long wavelength range occurs due to stimulated Raman scattering, the power of each wavelength channel of the WDM signal arriving at the reception node becomes substantially constant. In other words, the power of each wavelength channel of the WDM signal is adjusted (or pre-equalized) at the transmission node so that the power of each wavelength channel of the WDM signal arriving at the reception node becomes substantially constant.

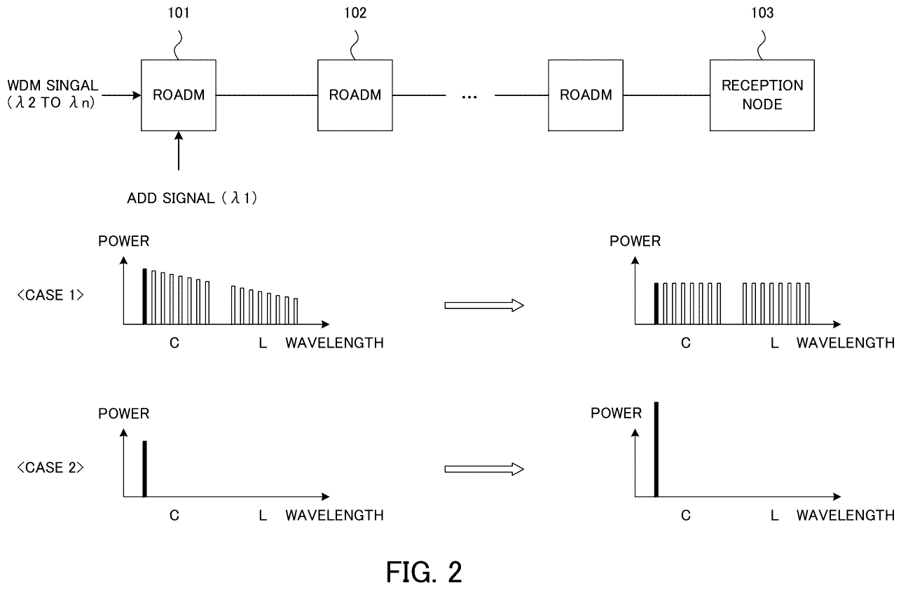

FIG. 2 illustrates an example of a transient response caused by input interruption (or Loss of Light) of the WDM signal. In this embodiment, an add signal is inserted into the WDM signal in a reconfigurable optical add drop multiplexer (ROADM) 101. The WDM signal includes wavelength channels λ1-λn. The wavelength channels λ2-λn are used in the WDM signal input to the ROADM 101. The add signal is inserted into the wavelength channel λ1. The wavelength λ1 is the shortest one among the wavelengths λ1-λn.

In a case 1, as described with reference to FIG. 1B, the ROADM 101 generates and outputs the WDM signal having the large power in the short wavelength range and the small power in the long wavelength range. Here, the wavelength of the wavelength channel λ1 into which the add signal is inserted is short. Therefore, in the ROADM 101, the power of the add signal (that is, the wavelength channel λ1) is controlled to be larger than that of other wavelength channels, as described with reference to FIG. 1B. Then, the power of each wavelength channel of the WDM signal received by the next node (ROADM 102) becomes substantially uniform.

The ROADM 102 also outputs the WDM signal having the large power in the short wavelength range and the small power in the long wavelength range. Then, the power of each wavelength channel of the WDM signal received by the next node becomes substantially uniform. Similarly, each ROADM outputs the WDM signal having the large power in the short wavelength range and the small power in the long wavelength range. As a result, the power of each wavelength channel of the WDM arriving at a reception node 103 is substantially uniform.

In a case 2, the optical fiber on the input side of the ROADM 101 is disconnected, and no WDM signal is input to the ROADM 101. In this case, the ROADM 101 outputs only the add signal inserted into the wavelength channel λ1. However, since the other wavelength channels do not propagate the optical signal, a power shift due to stimulated Raman scattering does not occur. That is, a power shift from the wavelength channel λ1 to another wavelength channel does not occur.

As described above, when the optical fiber propagating the WDM signal is disconnected and many wavelength channels (in this example, λ2-λn) in the WDM signal are stopped, the power of the remaining wavelength channels (in this example, λ1) fluctuates. That is, a transient response (or transient) occurs. Then, since the transient response is accumulated in each span, the power of the remaining signal arriving at the reception node 103 may become very large. In this case, in the reception node 103, when the power of the remaining signal exceeds a dynamic range of photo detector element, an error occurs. Alternatively, in a case where the power of the remaining signal is very large, the photo detector element may fail.

It is noted that, in many cases, the ROADM can individually control the optical power of each wavelength channel. Therefore, when detecting the input interruption (or Loss of Light) of the WDM signal, the ROADM may control the power of the remaining wavelength channel so as to reduce the transient response. However, the transient response due to stimulated Raman scattering is significantly fast (for example, 100 microseconds to 1 millisecond). Therefore, in the procedure of detecting the input interruption and controlling the power of the wavelength channel, it is difficult to suppress the transient response caused by stimulated Raman scattering.

In addition, in the example illustrated in FIG. 2, since the remaining signal is allocated in the short wavelength range in the signal band of the WDM signal, the power of the remaining signal increases at the reception node. On the other hand, when the remaining signal is allocated in the long wavelength range in the signal band of the WDM signal, the power of the remaining signal decreases at the reception node. In this case, an error may occur in the reception node.

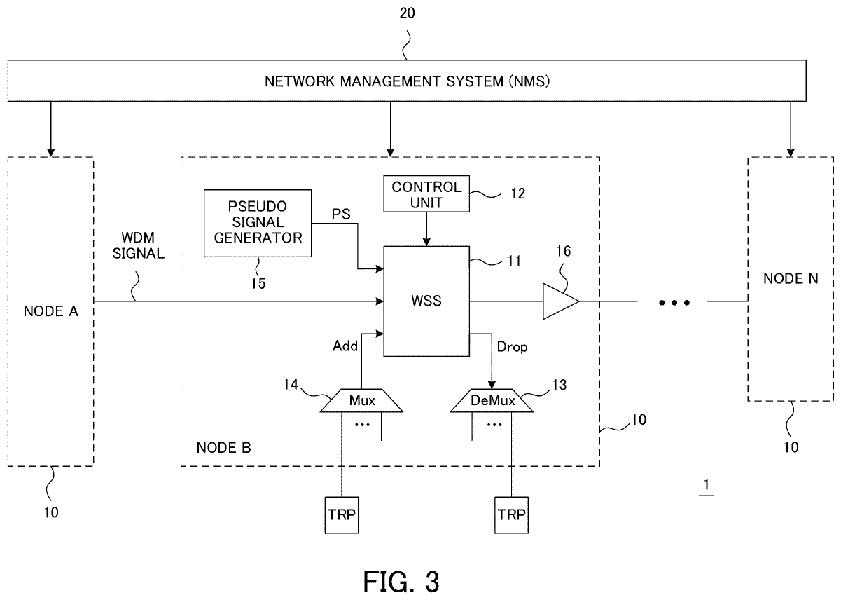

FIG. 3 illustrates an example of an optical transmission system according to the embodiment of the present disclosure. An optical transmission system 1 according to the embodiment includes a plurality of WDM nodes (nodes A to N) 10 and a network management system (NMS) 20. The ROADM is provided on each of the nodes A to N. FIG. 3 illustrates the ROADM provided on the node B. Although the WDM signal is transmitted from the node A to the node N in FIG. 3, the optical transmission system 1 can also transmit the WDM signal from the node N to the node A. Hereinafter, a case in which the WDM signal is transmitted from the node A to the node N will be described.

The ROADM includes a wavelength selective switch (WSS) circuit 11. The WSS circuit 11 is an example of a wavelength processing circuit, and can individually process a plurality of wavelength channels multiplexed in the WDM signal.

The WSS circuit 11 may terminate the desired one or more optical signals from the input WDM signal. The wavelength of the optical signal to be terminated is designated by a control unit 12. The optical signal terminated by the WSS circuit 11 is guided to a demultiplexer (DeMux) 13 via a drop port of the WSS circuit 11. The demultiplexer 13 is realized by, for example, a multicast switch (MCS). Then, the demultiplexer 13 guides the optical signal terminated from the input WDM signal to a corresponding transponder (TRP). Each transponder is connected to, for example, an access line or a client device. It is noted that “terminating an optical signal from a WDM signal” includes branching the optical signal from the WDM signal and removing the optical signal from the WDM signal.

The WSS circuit 11 can insert the optical signal into an unused channel of the WDM signal. That is, the optical signal transmitted from the access line or the client device is guided to an add port of the WSS circuit 11 via a multiplexer (Mux) 14. When the WSS circuit 11 terminates the optical signal from the input WDM signal, the ROADM can insert a new optical signal into a wavelength channel to which the terminated optical signal has been allocated. The multiplexer 14 is realized by, for example, a multicast switch (MCS).

The ROADM further includes a pseudo signal generator 15 that generates a pseudo signal (PS). The pseudo signal is an optical signal that does not carry data or information. The pseudo signal is guided to a predetermined input port of the WSS circuit 11. Then, the pseudo signal generator 15 generates the pseudo signal in the unused channel of the WDM signal. It is noted that the pseudo signal generator 15 is not particularly limited, but may be realized by using, for example, an amplified spontaneous emission (ASE) light source and WSS.

The control unit 12 controls the operation of the ROADM. In addition, the control unit 12 configures the state of the WSS circuit 11. Specifically, the control unit 12 configures the WSS circuit 11 to terminate one or more optical signals from the input WDM signal in response to an instruction from the network management system 20. In addition, the control unit 12 configures the WSS circuit 11 to insert one or a plurality of optical signals into the WDM signal in response to an instruction from the network management system 20.

The network management system 20 manages communication of the optical transmission system 1 and controls the operation of each WDM node 10. For example, the network management system 20 manages a wavelength allocated to each optical path, generates control information for setting the WSS circuit 11 provided on each WDM node 10, and provides the control information to each WDM node 10. In addition, the network management system 20 determines a wavelength channel into which a pseudo signal is to be inserted and notifies each WDM node 10 of the wavelength channel.

In the optical transmission system 1 having the above-described configuration, the WDM signal transmitted from the node A arrives at the node B. The WDM signal includes a plurality of wavelength channels, and transmits an actual signal and a pseudo signal. That is, the WDM signal includes a wavelength channel that propagates the actual signal and a wavelength channel that propagates the pseudo signal. The actual signal represents an optical signal carrying data or information. The data or the information is generated, for example, by a client. As described above, the pseudo signal is an optical signal that does not carry data or information, and is inserted by the WDM node 10. For example, the pseudo signal in the WDM signal received by the node B is generated and inserted by the node A.

Preferably, all the wavelength channels of the WDM signal are used in transmission between the nodes. That is, when the WDM signal carries the actual signal by using one or more wavelength channels, it is preferable that the pseudo signal is inserted into all the remaining wavelength channels.

The WSS circuit 11 branches the pseudo signal from the input WDM signal. Here, the pseudo signal branched from the input WDM signal may be discarded without being used. That is, the WSS circuit 11 substantially removes the pseudo signal from the input WDM signal. When the input WDM signal includes a drop signal to be guided to the access line, the WSS circuit 11 branches the drop signal from the input WDM signal. The drop signal is an actual signal carrying data or information. The drop signal branched at the node B represents an optical signal to be guided to the access line of the node B, and is designated by the network management system 20.

It is noted that, in the following description, the WDM signal from which the drop signal and the pseudo signal are branched by the WSS circuit 11 may be referred to as an “intra-node WDM signal”. However, when the input WDM signal does not include the drop signal, the “intra-node WDM signal” represents a WDM signal obtained by terminating the pseudo signal by the WSS circuit 11.

As described above, the intra-node WDM signal is generated by branching the pseudo signal (and the drop signal) from the input WDM signal. Therefore, the wavelength channel to which the pseudo signal (and the drop signal) has been allocated in the input WDM signal will be an unused channel in the intra-node WDM signal.

The WSS circuit 11 inserts an add signal and a new pseudo signal into the unused channel(s) of the intra-node WDM signal. The add signal is an optical signal received via an access line. The add signal is an actual signal carrying data or information. The new pseudo signal is generated by the pseudo signal generator 15. Then, the WSS circuit 11 generates a transmission WDM signal by inserting the add signal and the new pseudo signal into the intra-node WDM signal.

The transmission WDM signal is amplified by an optical amplifier 16 and then transmitted to the adjacent node. The optical amplifier 16 is, for example, an erbium doped fiber amplifier (EDFA). When the WDM signal includes a C-band optical signal and an L-band optical signal, the optical amplifier 16 may include an optical amplifier that amplifies a C-band and an optical amplifier that amplifies a L-band.

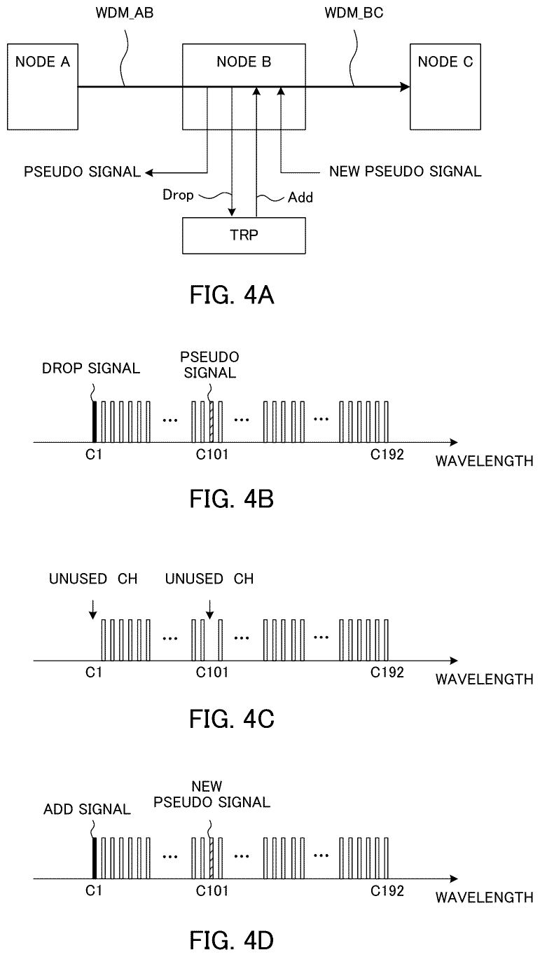

FIGS. 4A to 4D, 5A to 5C, 6A to 6D, and 7A to 7C illustrate an operation example of the optical transmission system 1. In this embodiment, the WDM signal is formed of 192 wavelength channels. The 192 wavelength channels C1 to C192 include, for example, 96 wavelength channels arranged in the C-band and 96 wavelength channels arranged in the L-band. In the C-band, the 96 wavelength channels are arranged at equal spacing, and in the L-band, the 96 wavelength channels are arranged at equal spacing. Hereinafter, a node B provided between a node A and a node C processes the WDM signal propagating from the node A to the node C.

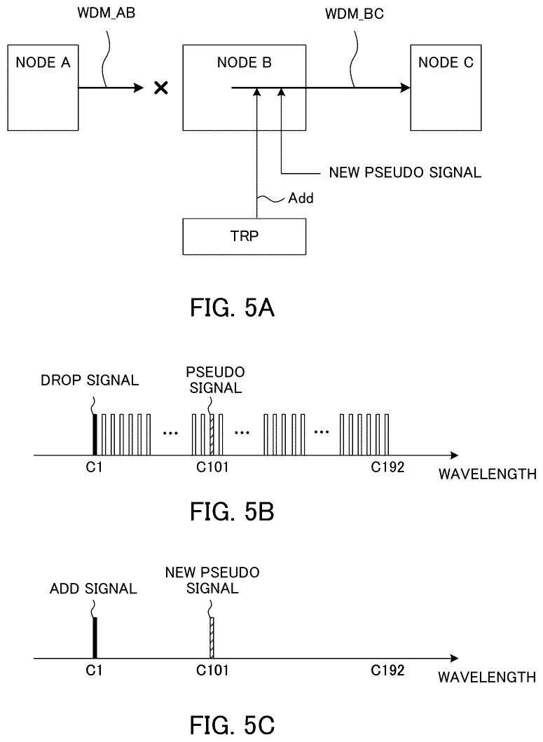

In the cases illustrated in FIGS. 4A to 4D and 5A to 5C, one of the 192 wavelength channels is used to transmit a pseudo signal. As an example, the wavelength channel C101 is used to transmit the pseudo signal.

FIGS. 4A to 4D illustrate a case in which the optical transmission system 1 operates normally. That is, as illustrated in FIG. 4A, the WDM signal transmitted from the node A is forwarded to the node C via the node B.

As illustrated in FIG. 4B, a WDM signal (WDM_AB) transmitted from the node A includes a drop signal and a pseudo signal. The drop signal is an actual signal to be branched at the node B. In addition, the drop signal is arranged in the wavelength channel C1.

As illustrated in FIG. 4A, the node B branches the drop signal and the pseudo signal from the WDM signal (WDM_AB). That is, the drop signal and the pseudo signal are removed from the WDM signal (WDM_AB). As a result, an intra-node WDM signal illustrated in FIG. 4C is generated. In the intra-node WDM signal, the wavelength channel C1 and the wavelength channel C101 are unused.

In addition, the node B inserts an add signal and a new pseudo signal into an unused channel of the intra-node WDM signal. For example, the add signal arrives at the node B via the access line. The new pseudo signal is generated in the node B. The add signal is inserted into the wavelength channel C1, and the new pseudo signal is inserted into the wavelength channel C101. That is, the add signal is inserted into the wavelength channel in which the drop signal has been arranged, and the new pseudo signal is inserted into the wavelength channel in which the pseudo signal has been arranged. As a result, a WDM signal (WDM_BC) illustrated in FIG. 4D is generated. Then, the node B transmits the WDM signal (WDM_BC) to the node C.

FIGS. 5A to 5C illustrate an example of the operation of the optical transmission system 1 when the optical fiber that transmits the optical signal from the node A to the node B is disconnected. In this case, the node A transmits a WDM signal (WDM_AB) illustrated in FIG. 5B, similarly to the cases illustrated in FIGS. 4A to 4D. However, the WDM signal (WDM_AB) does not arrive at the node B as illustrated in FIG. 5A.

Similarly to the cases illustrated in FIGS. 4A to 4D, the node B inserts an add signal into the wavelength channel in which the drop signal has been arranged, and inserts a new pseudo signal into the wavelength channel in which the pseudo signal has been arranged. Specifically, the add signal is inserted into the wavelength channel C1, and the new pseudo signal is inserted into the wavelength channel C101. As a result, a WDM signal (WDM_BC) illustrated in FIG. 5C is generated. Accordingly, the node B transmits the WDM signal (WDM_BC) to the node C.

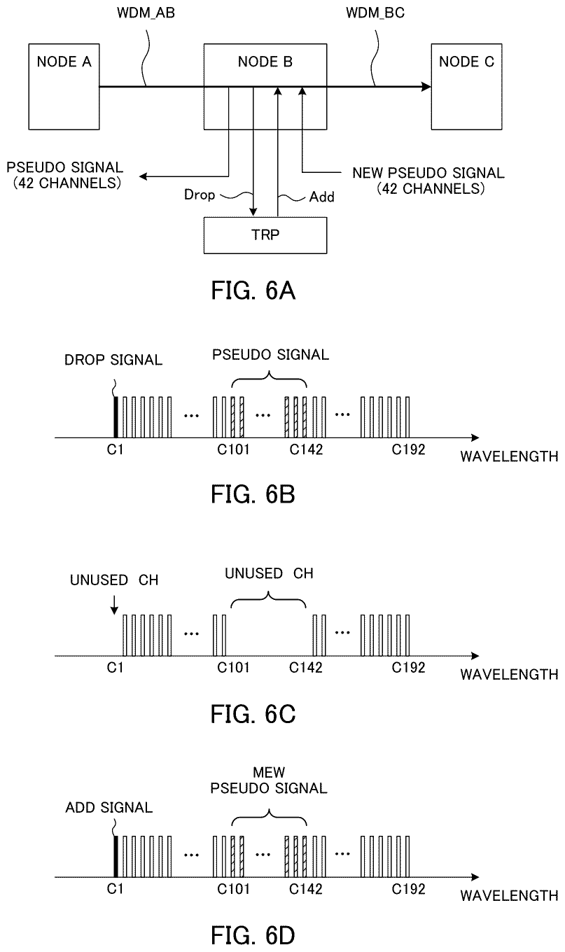

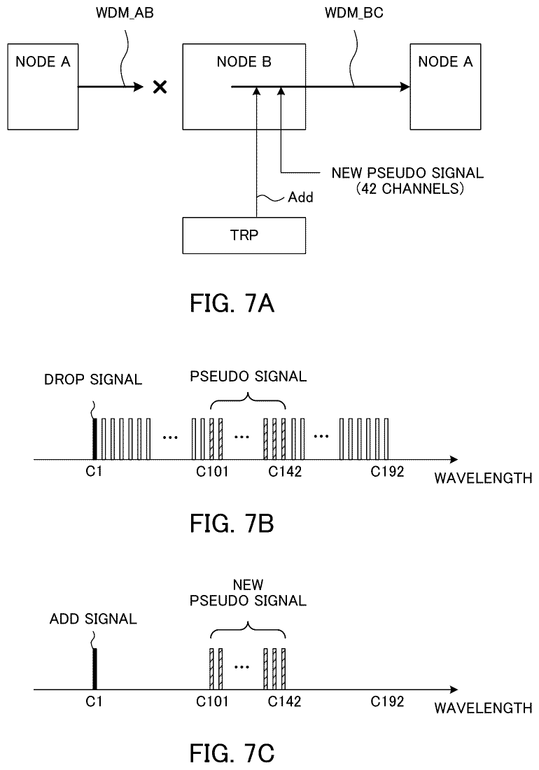

In the cases illustrated in FIGS. 6A to 6D and 7A to 7C, about 20% of the 192 wavelength channels are used to transmit the pseudo signal. As an example, 42 wavelength channels C101 to C142 are used to transmit the pseudo signal.

FIGS. 6A to 6D illustrate a case in which the optical transmission system 1 operates normally. That is, as illustrated in FIG. 6A, a WDM signal transmitted from the node A is forwarded to the node C via the node B.

As illustrated in FIG. 6B, a WDM signal (WDM_AB) transmitted from the node A includes a drop signal and pseudo signals. The drop signal is arranged in the wavelength channel C1. The pseudo signals are arranged in the wavelength channels C101 to C142.

As illustrated in FIG. 6A, the node B branches the drop signal and the pseudo signals from the WDM signal (WDM_AB). That is, the drop signal and the pseudo signals are removed from the WDM signal (WDM_AB). As a result, an intra-node WDM signal illustrated in FIG. 6C is generated. In this intra-node WDM signal, the wavelength channel C1 and the wavelength channels C101 to C142 are unused.

The node B inserts an add signal and new pseudo signals into unused channels of the intra-node WDM signal. The add signal is inserted into the wavelength channel C1, and new pseudo signals are respectively inserted into the wavelength channels C101 to C142. That is, the add signal is inserted into the wavelength channel in which the drop signal has been arranged, and the new pseudo signals are inserted into the wavelength channels in which the pseudo signals have been arranged. As a result, a WDM signal (WDM_BC) illustrated in FIG. 6D is generated. Then, the node B transmits the WDM signal (WDM_BC) to the node C.

FIGS. 7A to 7C illustrate an example of the operation of the optical transmission system 1 when the optical fiber that transmits the optical signal from the node A to the node B is disconnected. In this case, the node A transmits a WDM signal (WDM_AB) illustrated in FIG. 7B, similarly to the cases illustrated in FIGS. 6A to 6D. However, the WDM signal (WDM_AB) does not arrive at the node B as illustrated in FIG. 7A.

Similarly to the cases illustrated in FIGS. 6A to 6D, the node B inserts an add signal into the wavelength channel in which the drop signal has been arranged, and inserts new pseudo signals into the wavelength channels in which the pseudo signals have been arranged. Specifically, the add signal is inserted into the wavelength channel C1, and the new pseudo signals are respectively inserted into the wavelength channels C101 to C142. As a result, a WDM signal (WDM_BC) illustrated in FIG. 7C is generated. Accordingly, the node B transmits the WDM signal (WDM_BC) to the node C.

As described above, in the optical transmission system 1, even when the input of the WDM signal to the WDM node 10 is stopped, the WDM node 10 outputs the pseudo signal in addition to the add signal. For example, in the cases illustrated in FIGS. 5A to 5C, when the WDM signal transmitted from the node A does not arrive at the node B, the node B outputs the add signal and one pseudo signal. In the cases illustrated in FIGS. 7A to 7C, when the WDM signal transmitted from the node A does not arrive at the node B, the node B outputs the add signal and 42 pseudo signals.

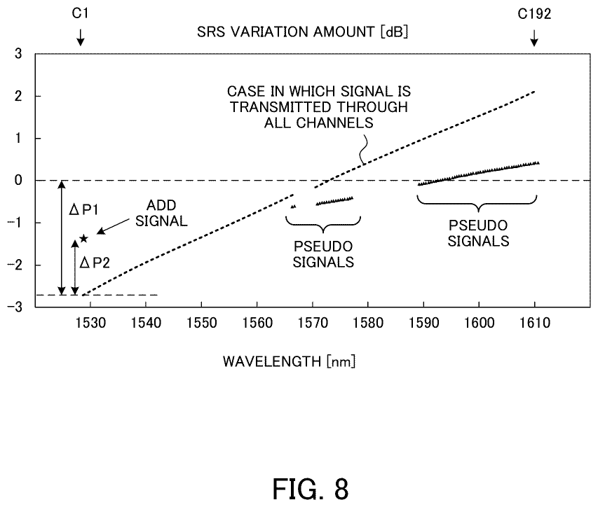

FIG. 8 is a diagram illustrating an effect of transmitting the pseudo signal. In this example, the WDM signal includes 192 wavelength channels (C1 to C192). The wavelength channels C1 to C96 are arranged in the C-band, and the wavelength channels C97 to C192 are arranged in the L-band.

A horizontal axis of the graph illustrated in FIG. 8 represents a wavelength. A vertical axis represents the amount of variation in optical power per span due to stimulated Raman scattering. A broken line represents a variation amount of the optical power when the optical signal is transmitted through all the wavelength channels of the WDM signal.

When the WDM signal is transmitted via the optical fiber, a part of the power of the optical signal in the short wavelength range is absorbed by the optical signal in the long wavelength range by stimulated Raman scattering. Therefore, for example, the optical power of the optical signal having the shortest wavelength in the WDM signal (In FIG. 8, the wavelength channel C1) decreases by about 2.7 dB due to stimulated Raman scattering. In addition, the optical power of the optical signal having the longest wavelength (In FIG. 8, wavelength channel C192) increases by about 2.1 dB.

On the other hand, when the WDM signal transmits only one optical signal (for example, the wavelength channel C1), the variation in optical power due to stimulated Raman scattering is substantially zero. Therefore, for example, when a state in which the optical signal is transmitted through all the wavelength channels of the WDM signal transitions to a state in which the optical signal is transmitted only through the wavelength channel C1 due to disconnection of the optical fiber or the like, the optical power of the wavelength channel C1 transiently increases by ΔP1 (about 2.7 dB). Here, a variation in optical power (that is, transient response) due to stimulated Raman scattering occurs for each span. Then, when the WDM signal is transmitted through a plurality of spans, the transient responses caused by stimulated Raman scattering are accumulated. That is, the transient response when the WDM signal is transmitted over two spans is about 5.4 dB, and the transient response when the WDM signal is transmitted over three spans is about 8.1 dB.

Here, when the cumulative transient response exceeds 10 dB, it is assumed that a transmission error exceeding a threshold level occurs in the reception node. In this case, in the worst case (that is, a case in which a state in which the optical signal is transmitted through all the wavelength channels of the WDM signal transitions to a state in which the optical signal is transmitted only through the wavelength channel C1), an error exceeding a threshold level occurs in four-span transmission.

In the embodiment of the present disclosure, each WDM node 10 generates and outputs a pseudo signal. In the example illustrated in FIG. 8, the WDM node 10 outputs an add signal using the wavelength channel C1 and outputs pseudo signals via the wavelength channels C95 to C102 and C142 to C192. That is, 69 pseudo signals are output together with the add signal. Therefore, when the input of the WDM signal to the WDM node 10 is stopped, a state transitions from a state in which the optical signal is transmitted via all the wavelength channels of the WDM signal to a state in which 70 optical signals (that is, the add signal and the 69 pseudo signals) are transmitted. At this time, a part of the optical power of the add signal is absorbed by the pseudo signals by stimulated Raman scattering. As a result, the optical power of the add signal transmitted using the wavelength channel C1 decreases by about 1.4 dB due to stimulated Raman scattering as indicated by a star symbol in FIG. 8.

Therefore, when the input of the WDM signal to the WDM node 10 is stopped, the optical power of the wavelength channel C1 transiently increases by ΔP2 (about 1.3 dB). That is, the transient response is smaller than that in the case where the pseudo signal is not transmitted. As a result, in a case where a transmission error exceeding the threshold level occurs at the reception node when the cumulative transient response exceeds 10 dB, six-span transmission can be performed using the wavelength channel C1. As described above, according to the embodiment, since the transient response is suppressed by inserting the pseudo signals into the WDM signal, the number of spans capable of transmitting the optical signal increases.

The effect of suppressing the transient response depends on the number of pseudo signals inserted into the WDM signal. That is, as the number of pseudo signals increases, the transient response is suppressed. In the example illustrated in FIG. 8, the transient response per span is improved (or reduced) by 1.4 dB by inserting the pseudo signals into 69 wavelength channels among the 192 channels. Therefore, in order to sufficiently suppress the transient response, as an example, a channel usage rate may be limited to 70 to 80 percent, and the pseudo signal may be inserted into 20 to 30 percent of the wavelength channels.

However, increasing the number of pseudo signals reduces the number of wavelength channels for transmitting data or information. That is, transmission efficiency deteriorates. Therefore, it is preferable to determine an upper limit of the channel usage rate in consideration of both suppression of transient responses (that is, the number of spans capable of transmitting the optical signals) and transmission efficiency.

It is noted that the transient response caused by a change in the number of wavelength channels that transmit signals may be suppressed using a feedback system including a variable optical attenuator. However, the transient response by stimulated Raman scattering is significantly fast. Therefore, in order to sufficiently suppress the transient response in the feedback system, it is necessary to increase the speed of the variable optical attenuator and, as such costs increase or it is difficult to realize the desired purpose. In contrast, embodiments of the present disclosure utilize an inexpensive ASE light source and an existing WSS to suppress the transient response, which is advantageous in cost and easy to implement.

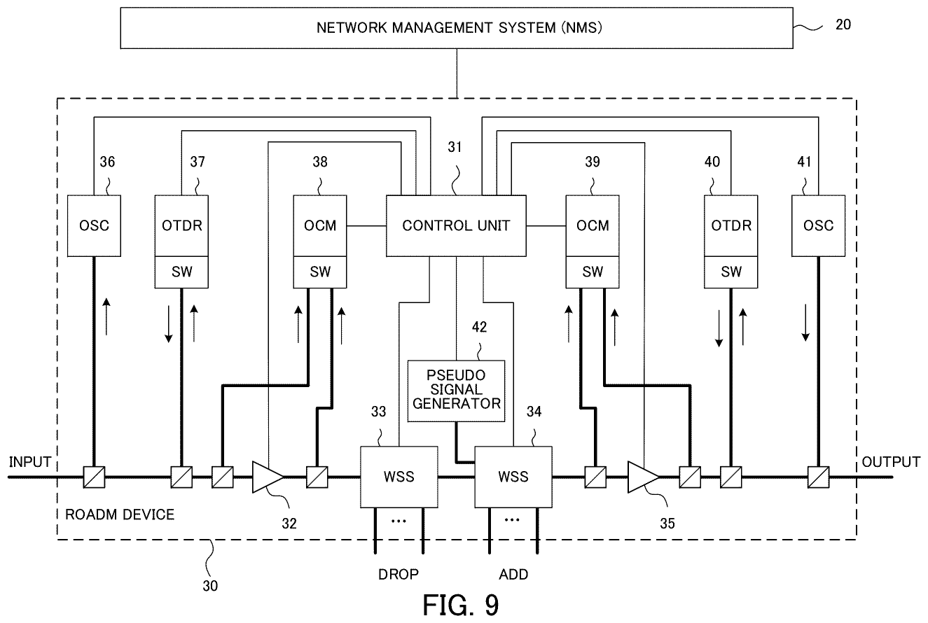

FIG. 9 illustrates an example of a ROADM device provided on each WDM node. As illustrated in FIG. 9, a ROADM device 30 includes a control unit 31, an optical amplifier 32, a WSS 33, a WSS 34, an optical amplifier 35, an optical supervisory channel (OSC) circuit 36, an optical time domain reflectometer (OTDR) 37, an optical channel monitor (OCM) 38, an optical channel monitor 39, an OTDR 40, an OSC circuit 41, and a pseudo signal generator 42. It is noted that the ROADM device 30 may further include other circuits or devices not illustrated in FIG. 9.

The control unit 31 includes a processor and a memory, and controls an operation of the ROADM device 30 in response to an instruction transmitted from the network management system 20. Furthermore, the control unit 31 may control the operation of the ROADM device 30 based on an OSC signal received by the OSC circuit 36 or the OSC circuit 41. Furthermore, the control unit 31 may control the operation of the ROADM device 30 based on control information stored in a header of a packet received via any wavelength channel in the WDM signal.

The optical amplifier 32 amplifies an input WDM signal. In addition, the optical amplifier 35 amplifies an output WDM signal. The gains of the optical amplifier 32 and the optical amplifier 35 may be adjusted by the control unit 31.

The WSS 33 and the WSS 34 correspond to the WSS circuit 11 illustrated in FIG. 3, and can individually process a plurality of wavelength channels in the WDM signal. The WSS 33 may branch a drop signal from the input WDM signal in response to an instruction from the control unit 31. The drop signal branched from the input WDM signal is guided to a corresponding transponder by the demultiplexer as described with reference to FIG. 3. When the input WDM signal includes a pseudo signal, the WSS 33 branches the pseudo signal from the input signal. The WSS 33 does not need to output the pseudo signal branched from the input WDM signal. That is, the WSS 33 removes the pseudo signal from the input WDM signal. Then, the WSS 33 outputs an intra-node WDM signal obtained by branching the drop signal and the pseudo signal from the input WDM signal.

The WSS 34 can insert an add signal into the intra-node WDM signal. The add signal is transmitted from a corresponding transponder and is guided to the WSS 34 via the multiplexer, as described with reference to FIG. 3. In addition, the WSS 34 can insert a new pseudo signal into the intra-node WDM signal. Then, the WSS 34 outputs the WDM signal into which the add signal and the new pseudo signal are inserted. It is noted that the new pseudo signal is generated by the pseudo signal generator 42 to be described later.

The OSC circuit 36 receives an OSC signal transmitted from a neighboring node. The OSC signal is an optical signal having a specified wavelength allocated outside a wavelength band of the WDM signal. In addition, the OSC signal is used to notify control information between nodes. For example, the OSC signal may notify the adjacent node of information indicating a wavelength to branch from the WDM signal and information indicating a wavelength at which the pseudo signal is arranged. Then, the OSC circuit 36 forwards the control information transmitted by the OSC signal to the control unit 31. In addition, the OSC circuit 41 generates an OSC signal and transmits the OSC signal to the adjacent node in response to an instruction from the control unit 31.

The OTDRs 37 and 40 measure a state of an optical fiber cable by inputting an optical pulse to the optical fiber cable and monitoring the reflected pulse. The control unit 31 is notified of the measurement results of the OTDRs 37 and 40.

The optical channel monitor 38 detects power of each wavelength channel of the input WDM signal. Here, the optical channel monitor 38 may detect optical power before being amplified by the optical amplifier 32 and optical power after being amplified by the optical amplifier 32. The optical channel monitor 39 detects power of each wavelength channel of the output WDM signal. Here, the optical channel monitor 39 may detect optical power before being amplified by the optical amplifier 35 and optical power after being amplified by the optical amplifier 35.

The pseudo signal generator 42 outputs light having a wavelength designated by the control unit 31 as a pseudo signal. In the example illustrated in FIGS. 6A to 6D and 7A to 7C, the pseudo signal generator 42 generates light having a wavelength corresponding to the wavelength channels C101 to C142.

The pseudo signal generator 42 is realized by, for example, an ASE light source and a WSS. The ASE light source outputs high-luminance and broadband ASE light. The WSS operates as an optical filter that allows a wavelength component to be used as a pseudo signal to pass through the ASE light. In this case, control information indicating the wavelength of the pseudo signal is provided to the WSS. Then, the WSS generates the pseudo signal by filtering (or channelizing) the ASE light according to the control information. Alternatively, the WSS 34 may be used to generate the pseudo signal. For example, the ASE light is input to a specified input port of the WSS 34. Then, the WSS 34 is configured to operate as an optical filter that allows a wavelength component to be used as a pseudo signal to pass therethrough. In this case, the pseudo signal generator 42 is realized by the ASE light source and the WSS 34.

The network management system 20 manages communication of the optical transmission system 1 and controls the operation of each WDM node 10. For example, the network management system 20 notifies each WDM node of information indicating the wavelength of the optical signal to be inserted into the WDM signal and information indicating the wavelength of the optical signal to be branched from the WDM signal. In addition, the network management system 20 determines a wavelength channel into which a pseudo signal is to be inserted and notifies each WDM node 10 of the wavelength channel.

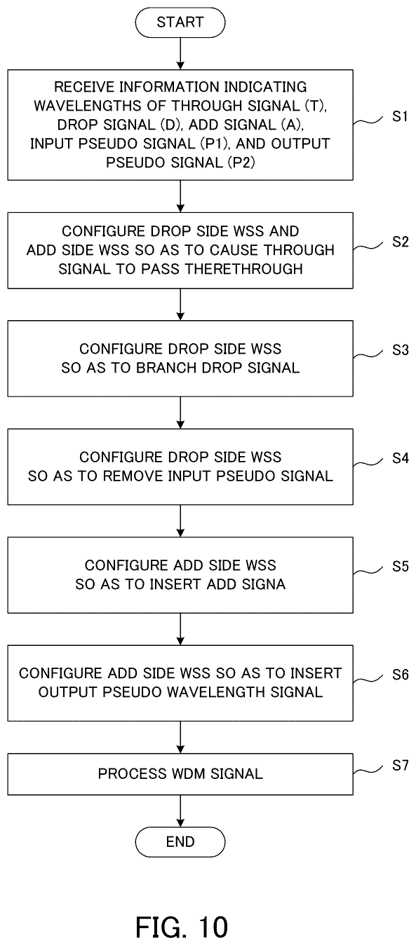

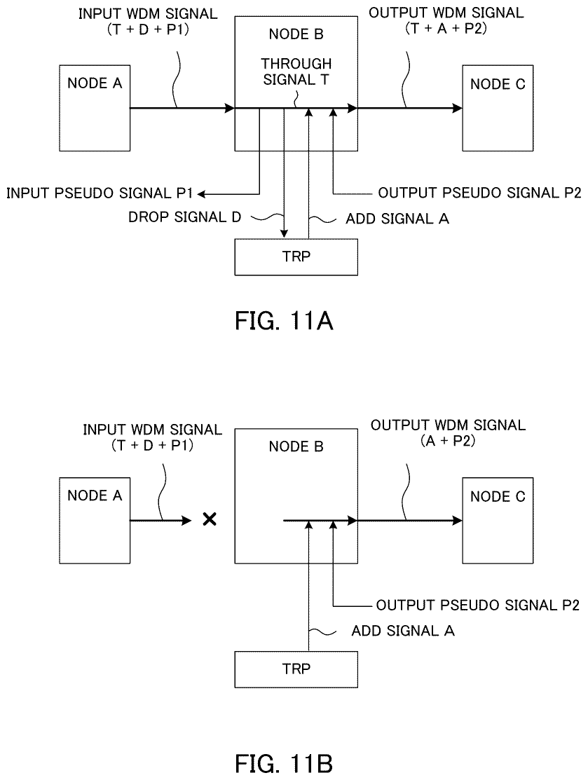

FIG. 10 is a flowchart illustrating an example of a process of the ROADM device 30. FIG. 10 illustrates a procedure related to control of the WSS circuit. FIG. 10 also represents the operation of the ROADM device 30 provided on a node B illustrated in FIG. 11A or 11B. In the case illustrated in FIG. 11A or 11B, the WDM signal is transmitted from the node A to the node C via the node B.

In S1, the ROADM device 30 receives wavelength configuration information related to the configuration of the WSS circuit from the network management system 20. The wavelength configuration information indicates a wavelength of a through signal T, a wavelength of a drop signal D, a wavelength of an add signal A, a wavelength of an input pseudo signal P1, and a wavelength of an output pseudo signal P2. The through signal T represents an actual signal forwarded to the node C without being branched at the node B among the actual signals in the WDM signal transmitted from the node A. The drop signal D represents an optical signal being branched from the WDM signal at the node B. The add signal A represents an optical signal inserted into the WDM signal at the node B. The input pseudo signal P1 represents a pseudo signal transmitted from the node A to the node B. The output pseudo signal P2 represents a pseudo signal transmitted from the node B to the node C. It is noted that the network management system 20 notifies each node of the wavelength configuration information. It is noted that the wavelength configuration information is generated for each node by the network management system 20 and is notified to the corresponding node.

The wavelength configuration information may be notified to each node by another method. For example, the wavelength configuration information may be notified from the neighboring node using OSC. Alternatively, the wavelength configuration information may be stored in a header of a data packet transmitted via any wavelength channel in the WDM signal. In this case, the ROADM device 30 provided on each node may acquire the wavelength configuration information by analyzing the header of the received packet from the neighboring node.

In S2, the control unit 31 configures the WSS 33 and the WSS 34 such that the through signal T is forwarded to the node C without being branched at the node B. In S3, the control unit 31 configures the WSS 33 such that the drop signal D is branched from the WDM signal at the node B. At this time, the WSS 33 is configured such that the drop signal D is guided to the corresponding drop port. In S4, the control unit 31 configures the WSS 33 such that the input pseudo signal P1 is removed from the WDM signal at the node B. At this time, the WSS 33 is configured such that the input pseudo signal P1 is not output.

In S5, the control unit 31 configures the WSS 34 such that the add signal A is inserted into the WDM signal at the node B. At this time, the WSS 34 is configured such that input light of an add port is guided to an output port. In S6, the control unit 31 configures the WSS 34 such that the output pseudo signal P2 is inserted into the WDM signal at the node B. At this time, the WSS 34 is configured such that light provided from the pseudo signal generator 42 to the input port is guided to the output port.

In S7, the ROADM device 30 processes the WDM signal according to the configuration of S2 to S6. Then, the WDM signal arriving at the node B is processed as illustrated in FIG. 11A. That is, in the WSS 33, the drop signal D is branched from the WDM signal and is guided to the corresponding transponder, and the input pseudo signal P1 is removed from the WDM signal. As a result, an intra-node WDM signal including the through signal T is generated. Then, in the WSS 34, the add signal and the output pseudo signal P2 are inserted into the intra-node WDM signal. As a result, the node B outputs the WDM signal including the through signal T, the add signal A, and the output pseudo signal P2.

When the WDM signal transmitted from the node A does not arrive at the node B due to disconnection of the optical fiber cable or the like, the ROADM device 30 provided on the node B operates as illustrated in FIG. 11B. That is, the node B outputs the WDM signal including the add signal A and the output pseudo signal P2. It is noted that this operation is equivalent to an operation of inserting the add signal A and the output pseudo signal P2 into the intra-node WDM signal in which all the wavelength channels are unused channels in the WSS 34.

As described above, the ROADM device 30 provided on the node B outputs the pseudo signal in addition to the add signal even when the input of the WDM signal to the node B is stopped. Therefore, since a power shift due to stimulated Raman scattering occurs between the add signal and the pseudo signal, a transient response when the WDM signal is stopped is suppressed.

### Variations

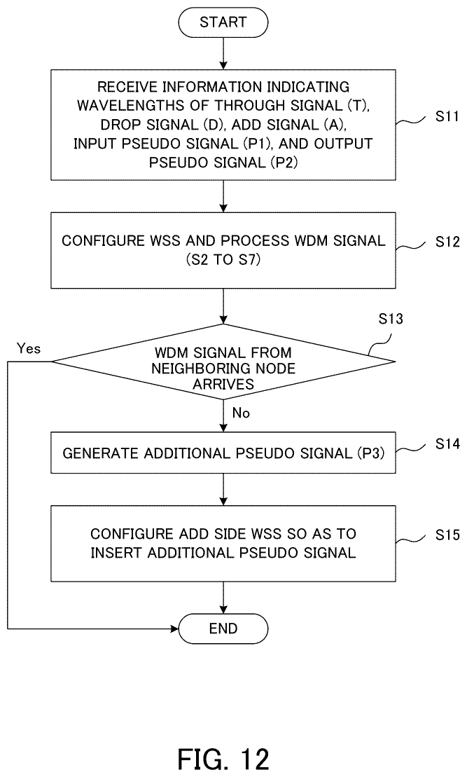

FIG. 12 is a flowchart illustrating a variation of a process of the ROADM device 30. It is noted that S11 is substantially the same as S1 illustrated in FIG. 10, and the ROADM device 30 receives the wavelength configuration information. In addition, S12 is substantially the same as S2 to S7 illustrated in FIG. 10, and the ROADM device 30 configures the WSS 33 and the WSS 34 according to the wavelength configuration information and processes the WDM signal.

In S13, the control unit 31 determines whether the WDM signal transmitted from the neighboring node (here, the node A) has arrived at the ROADM device 30. For example, when the OSC circuit 36 cannot detect the OSC signal, the control unit 31 determines that the WDM signal transmitted from the neighboring node has not arrived at the ROADM device 30. Alternatively, the control unit 31 may detect WDM signal interruption based on the optical power detected by the optical channel monitor 38.

When the WDM signal transmitted from the neighboring node arrives at the ROADM device 30, S14 to S15 are skipped. In this case, the ROADM device 30 performs the operation illustrated in FIG. 11A. That is, the ROADM device 30 outputs the through signal T, the add signal A, and the output pseudo signal P2.

On the other hand, when the WDM signal transmitted from the neighboring node does not arrive at the ROADM device 30, the ROADM device 30 performs the operation illustrated in FIG. 11B. That is, the ROADM device 30 outputs the add signal A and the output pseudo signal P2. In this case, the wavelength channel in which the through signal T is arranged becomes a free channel. Here, when the number of optical signals transmitted by the WDM signal changes, control for adjusting the gain of the optical amplifier is performed in each WDM node. Therefore, the number of optical signals transmitted by the WDM signal is preferably constant. Therefore, the ROADM device 30 performs the processes of S14 to S15 such that all wavelength channels transmit signals.

In S14, the ROADM device 30 generates an additional pseudo signal P3. The additional pseudo signal P3 is generated by the pseudo signal generator 42. A wavelength of the additional pseudo signal P3 is the same as the wavelength of the through signal T. It is noted that the wavelength of the through signal T is notified in S11.

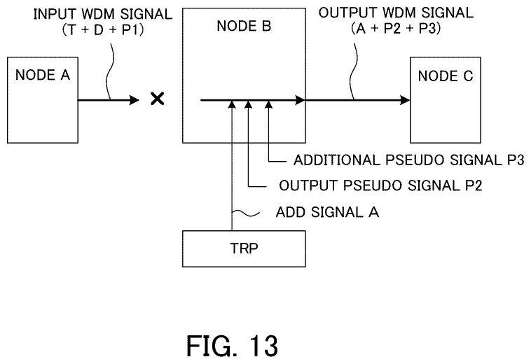

In S15, the control unit 31 configures the WSS 34 such that the additional pseudo signal P3 is inserted into the WDM signal at the node B. As a result, the additional pseudo signal P3 is inserted into the WDM signal. That is, as illustrated in FIG. 13, the ROADM device 30 outputs the add signal A, the output pseudo signal P2, and the additional pseudo signal P3. As a result, all wavelength channels of the WDM signal output from the node B transmit signals (actual signals or pseudo signals).

In the above-described embodiment, one drop signal is branched from the WDM signal in each WDM node, and one add signal is inserted into the WDM signal. However, the embodiment of the present disclosure is not limited to this configuration. That is, the ROADM device 30 provided on each WDM node may branch a desired number of drop signals from the WDM signal, and may insert a desired number of add signals into the WDM signal. In addition, the WDM signal may include one or more unused channels.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. An optical transmission system that transmits an optical signal via a plurality of nodes, wherein
a first optical transmission device provided on a first node among the plurality of nodes outputs a wavelength division multiplexed (WDM) signal including a wavelength channel configured to propagate an actual signal and a wavelength channel configured to propagate a pseudo signal, and
a second optical transmission device provided on a second node among the plurality of nodes includes
a wavelength processing circuit configured to terminate the pseudo signal in the WDM signal and to generate a second WDM signal by inserting an add signal and a new pseudo signal into unused wavelength channels of the WDM signal after the pseudo signal is terminated.

2. The optical transmission system according to claim 1, wherein
the wavelength processing circuit includes:
a first wavelength selective switch configured to terminate the pseudo signal in the WDM signal and to generate an intra-node WDM signal; and
a second wavelength selective switch configured to generate the second WDM signal by inserting the add signal and the new pseudo signal into unused wavelength channels of the intra-node WDM signal.

3. The optical transmission system according to claim 2, wherein
the actual signal propagated by the WDM signal includes a drop signal to be branched at the second node,
the first wavelength selective switch branches the drop signal and the pseudo signal from the WDM signal so as to generate the intra-node WDM signal, and
the second wavelength selective switch inserts the add signal into a wavelength channel in which the drop signal has been arranged and inserts the new pseudo signal into a wavelength channel in which the pseudo signal has been arranged.

4. The optical transmission system according to claim 2, wherein
the first wavelength selective switch generates the intra-node WDM signal by terminating all the pseudo signals in the WDM signal.

5. The optical transmission system according to claim 1, wherein
when the WDM signal output from the first node does not arrive at the second node, the wavelength processing circuit generates the second WDM signal by inserting the add signal into one of wavelength channels in the WDM signal and inserting the new pseudo signal into another wavelength channel in the WDM signal.

6. The optical transmission system according to claim 5, wherein
when the WDM signal output from the first node does not arrive at the second node, the wavelength processing circuit generates the second WDM signal by inserting the add signal into one of wavelength channels in the WDM signal and inserting the new pseudo signal into all other wavelength channels in the WDM signal.

7. The optical transmission system according to claim 1, wherein
a maximum number of wavelength channels allocated to transmit the actual signal is determined in advance.

8. The optical transmission system according to claim 1, wherein
wavelength configuration information that indicates wavelength channels of the WDM signal in which the actual signal and the pseudo signal are inserted is notified from a network management system configured to control a plurality of the optical transmission devices respectively provided on the plurality of nodes or the first node, and
the wavelength processing circuit terminates, based on the wavelength configuration information, the pseudo signal in the WDM signal.

9. The optical transmission system according to claim 1, wherein
the second optical transmission device further includes an amplified spontaneous emission (ASE) light source, and
the new pseudo signal is generated using ASE light output from the ASE light source.

10. An optical transmission device that processes a wavelength division multiplexed (WDM) signal including a wavelength channel configured to propagate an actual signal and a wavelength channel configured to propagate a pseudo signal, the optical transmission device comprising:
a first wavelength selective switch;
a second wavelength selective switch provided on an output side of the first wavelength selective switch; and
a processor configured to control the first wavelength selective switch and the second wavelength selective switch, wherein
the processor configures the first wavelength selective switch so as to branch the pseudo signal from the WDM signal, and
the processor configures the second wavelength selective switch so as to insert a new actual signal and a new pseudo signal into unused wavelength channels of the WDM signal.
